(19) United States
(12) Patent Application Publication
(10) Pub. No.: US 2008/0066028 A1
(43) Pub. Date: Mar. 13, 2008

(54) Logic circuit verifying apparatus

(76) Inventors: Shinsuke Honma, Osaka (JP); Akihiro Furuta, Osaka (JP)

Correspondence Address: MCDERMOTT WILL & EMERY LLP, 600 13TH STREET, NW, WASHINGTON, DC, 20005-3096, US

(21) Appl. No.: 11/896,018

(22) Filed: Aug. 29, 2007

(30) Foreign Application Priority Data
Sep. 12, 2006 (JP) P.2006-246911

(51) Int. Cl. G06F 17/50

(52) U.S. Cl. 716/5

(57) ABSTRACT

A logic circuit verifying apparatus is provided which can control function verification in response to reports in progress as to the function verification.

A logic circuit verifying apparatus is provided with: a first storage unit for storing thereinto circuit design information described in a hardware description language, in which a script description has been embedded in a description described in the hardware description language; a data converting unit for converting the hardware description portion of the circuit design information into first circuit data by compiling the circuit design information read from the first storage unit, and for converting the script description portion of the circuit design information into script data; a first simulation unit for performing a simulation by employing the first circuit data inputted from the data converting unit; and a script processing unit into which the script data is inputted from the data converting unit, and which processes the script data in response to an instruction issued from the first simulation unit.

### BACKGROUND OF THE INVENTION

1. Field of the Invention

The present invention is related to a logic circuit verifying apparatus which verifies a logic circuit designed by employing a hardware description language.

2. Description of the Related Art

Generally speaking, digital logic circuits are designed by employing hardware languages such as Verilog-HDL (Hardware Description Language) and VHDL. Normally, functions of digital logic circuits designed by the HDL language are verified by employing a computer program called as an “HDL simulator.” In an HDL simulator, test benches (verification environments) described in the HDL are entered in addition to circuits described in the HDL, so that function verification is carried out.

In connection with very fine techniques of semiconductor processes in the current year, a total number of logic gates which are integrated in a single LSI amounts to several thousands. In order to suppress developing terms and developing expenses for LSIs, it is desirable to effectively perform function verification. However, although computers can be operated in high speeds, a plenty of time is required for performing the function verification of the LSIs. For instance, 50 to 100 hours are necessarily required until an execution of a 1 pattern of function verification of an LSI designed for processing an image is accomplished, which is not a rare case. As a result, such systems have been proposed which may notify completions of function verification to homes of verification executing operators, while a patent publication 1 discloses one example of these notification systems.

While the notification system has been connected to the logic verification system in the above-described patent publication 1, when the logic verification is ended, the completion of the function verification is notified; a sort of completion under normal condition/completion under abnormal condition is notified; and in case of the completion under abnormal condition, the cause thereof is notified from the notification system to the operator by employing various means such as voice communications, FAX (facsimiles), and electronic mails.

Patent Publication 1: JP-A-11-252251

However, the above-described system contains the below-mentioned problems. As a first problem, in the above-explained system, the result of the function verification is notified to the operator only at a time instant when the function verification is accomplished, and thereafter, the operator must manually perform a certain measure. Nevertheless, in an actual case, there are many possibilities that in such a case where function verification is carried out for a predetermined time period under normal condition, operators subsequently start similar function verification without waiting for a completion of the first-mentioned function verification. As a consequence, it is desirable to provide such a function that reports in progress of one function verification are automatically judged so as to automatically commence another function verification. However, the above-described system is not equipped with this desirable function.

As a second problem, as to such a case that 100 hours are required in order to accomplish function verification, a size of a data file produced in the verification becomes large. Also, under general-purpose developing environment, a plurality of logic circuit verifying apparatuses share a file server. Thus, in the case that since a certain logic circuit verifying apparatus forms a huge amount of data files during function verification, a storage capacity of the formed data files exceeds a limit of a storage capacity of this file server, all of the logic circuit verifying apparatuses cannot continuously execute the function verification. As a consequence, in the case that a certain abnormal event appears in a half way of the function verification, it is desirable to immediately stop this function verification and to delete an unnecessary file. However, such a function is not provided in the above-described system.

As a third problem, in the above-described system, the results of the function verification are notified to the operator only at the time instant when the function verification is accomplished. When the function verification results correspond to the abnormal completion, after the cause of this abnormal completion is solved, the function verification is required to be restarted. However, in such a case that 100 hours are required in order to accomplish the function verification, if the abnormal completion and the reexecution of the function verification are repeatedly carried out, then a developing term of an LSI is prolonged. As a consequence, in the case where a certain abnormal event appears in a half way of the function verification, it is desirable that such an abnormal event is immediately notified to the operator and the operator can arbitrarily change the abnormal detected portion. However, such a desirable function is not provided in the above-explained system.

As a fourth problem, in the above-described system, the completion of the function verification is notified to the operator located at the remote place. Then, the operator judges the results of the function verification; when the abnormal completion occurs, the operator analyzes the cause thereof; and when the function verification is accomplished under normal condition, the operator continuously executes another function verification. As a consequence, it is desirable that even when the operator is located at the remote place, the operator can start another function verification. However, such a desirable function is not provided in the above-described system.

### SUMMARY OF THE INVENTION

An object of the present invention is to provide a logic circuit verifying apparatus capable of controlling function verification in response to reports in progress of the function verification.

The present invention is to provide a logic circuit verifying apparatus comprising: a first storage unit for storing thereinto circuit design information described in a hardware description language, in which a script description has been embedded in a description described in the hardware description language; a data converting unit for converting the hardware description portion of the circuit design information into first circuit data by compiling the circuit design information read from the first storage unit, and for converting the script description portion of the circuit design information into script data; a first simulation unit for performing a simulation by employing the first circuit data inputted from the data converting unit; and a script processing unit into which the script data is inputted from the data converting unit, and which processes the script data in response to an instruction issued from the first simulation unit.

Also, the present invention is to provide a logic circuit verifying apparatus comprising: a first storage unit for storing thereinto first circuit design information described in a hardware description language, in which a script description has been embedded in a description described in the hardware description language, and for storing thereinto second circuit design information described in the hardware description language; a first data converting unit for converting the hardware description portion of the first circuit design information into first circuit data by compiling the first circuit design information read from the first storage unit, and for converting the script description portion of the first circuit design information into script data; a second data converting unit for converting the hardware description portion of the second circuit design information into second circuit data by compiling the second circuit design information read from the first storage unit; a first simulation unit for performing a simulation by employing the first circuit data inputted from the first data converting unit; a script processing unit into which the script data is inputted from the first data converting unit, and which processes the script data in response to an instruction issued from the first simulation unit; and a second simulation unit for performing a simulation by employing the second circuit data inputted from the second data converting unit in response to an instruction issued from the script processing unit.

In the above-described logic circuit verifying apparatus, the first simulation unit temporarily interrupts the simulation while the script processing operation is carried out by the script processing unit, and restarts the simulation when the first simulation unit receives a script processing operation completion notification from the script processing unit.

In the above-described logic circuit verifying apparatus, either a file or a log file, which are produced while the simulation is performed by the first simulation unit, is stored in the first storage unit; and the script processing unit deletes, or compresses the file stored in the first storage unit by processing the script data.

In the above-described logic circuit verifying apparatus, the script processing unit processes the script data so as to control either an operating voltage or an operating frequency of the first simulation unit.

In the above-described logic circuit verifying apparatus, the logic circuit verifying apparatus is further comprised of: a second simulation unit for performing a simulation by employing a portion of the first circuit data transferred from the first simulation unit; the script processing unit processes the script data so as to instruct the first simulation unit in such a manner that the portion of the first circuit data is transferred to the second simulation unit in order to process the transferred data portion of the first circuit data in a distribution process manner; and the script processing unit processes the script data so as to instruct the second simulation unit to start a simulation by employing the data portion of the first circuit data as soon as the data portion of the first circuit data is transferred.

In the above-described logic circuit verifying apparatus, when the second simulation unit accomplishes the simulation by employing the data portion-of the first circuit data, the second simulation unit sends a completion notification to the script processing unit, and also, sends a simulation result to the first simulation unit; and when the script processing unit receives the completion notification, the script processing unit sends a distribution process operation completion notification to the first simulation unit.

In the above-described logic circuit verifying apparatus, the first simulation unit outputs simulation information indicative of reports in progress of the simulation which has been temporarily interrupted by that the script processing unit processes the script data; and in which the logic circuit verifying apparatus is further comprised of: a data format converting unit for converting the simulation information outputted from the first simulation unit into a data format for externally outputting the simulation information; and a data communication unit for outputting the externally-outputting simulation information converted by the data format converting unit to an external unit of the logic circuit verifying apparatus.

In the above-described logic circuit verifying apparatus, the data format converting unit converts the simulation information into a FAX output-purpose data format; and the data communication unit outputs the externally-outputting simulation information via a FAX (facsimile).

In the above-described logic circuit verifying apparatus, the data format converting unit converts the simulation information into an electronic mail output-purpose data format; and the data communication unit outputs the externally-outputting simulation information via an electronic mail.

In the above-described logic circuit verifying apparatus, the data communication unit receives an instruction for restarting, or stopping the simulation via an electronic mail; and the script processing unit instructs the first simulation unit to stop, or restart the simulation based upon the instruction.

In the above-described logic circuit verifying apparatus, the data format converting unit converts the simulation information into a voice output-purpose data format; and the data communication unit outputs the externally-outputting simulation information via voice.

In the above-described logic circuit verifying apparatus, the data communication unit receives the instruction for restarting, or stopping the simulation via voice; and the script processing unit instructs the first simulation unit to stop, or restart the simulation based upon the instruction.

The logic circuit verifying apparatus is further comprised of: a second recording unit for storing thereinto second circuit data and attribute information of the second circuit data; and a comparing unit for comparing the attribute information of the first circuit data with the attribute information of the second circuit data by processing the script data by the script processing unit.

The logic circuit verifying apparatus is further comprised of: a failure managing unit for storing thereinto information related to a failure which occurs in a simulation performed by the first simulation unit; and in which the script processing unit processes the script data so as to store the information related to the failure acquired from the first simulation unit in the failure managing unit.

The logic circuit verifying apparatus is further comprised of: an IP managing unit for storing thereinto information related to use results of an IP (Internet Protocol) which has been used in a simulation by the first simulation unit; and in which the script processing unit processes the script data so as to store the information related to the use results of the IP acquired from the first simulation unit in the IP managing unit.

The logic circuit verifying apparatus is further comprised of: an encrypted sentence decoding unit for decoding an encrypted sentence contained in the circuit design information.

In accordance with the logic circuit verifying apparatus of the present invention, the executions of other simulations can be automatically controlled, and the file operations can be automatically carried out in response to the reports in progress of the simulation. Also, the simulation reports in progress can be arbitrarily notified to the operator. Furthermore, the operator who is located at the remote place can judge the verification result and thus can control the continuation of the simulation.

### BRIEF DESCRIPTION OF THE DRAWINGS

FIG. 1 is a block diagram for showing a logic circuit verifying apparatus according to a first embodiment mode of the present invention.

FIG. 2 indicates an example of a source code in the logic circuit verifying apparatus of FIG. 1.

FIG. 3 is a block diagram for representing a logic circuit verifying apparatus according to a second embodiment mode of the present invention.

FIG. 4 is a block diagram for representing a logic circuit verifying apparatus according to a third embodiment mode of the present invention.

FIG. 5 is a block diagram for representing a logic circuit verifying apparatus according to a fourth embodiment mode of the present invention.

FIG. 6 is a block diagram for representing a logic circuit verifying apparatus according to a fifth embodiment mode of the present invention.

FIG. 7 is a block diagram for representing a logic circuit verifying apparatus according to a sixth embodiment mode of the present invention.

FIG. 8 is a block diagram for showing a system which contains the logic circuit verifying apparatus of the sixth embodiment mode, a FAX server, and a FAX.

FIG. 9 is a block diagram for showing a logic circuit verifying apparatus according to a seventh embodiment mode of the present invention.

FIG. 10 is a block diagram for showing a system which contains the logic circuit verifying apparatus of the seventh embodiment mode, a mail server, and a mail transmitting/receiving terminal.

FIG. 11 is a block diagram for representing a system in which a telephone server and a telephone terminal are added to the systems of FIG. 8 and FIG. 10.

FIG. 12 is a block diagram for indicating a logic circuit verifying apparatus according to an eighth embodiment mode of the present invention.

FIG. 13 is a block diagram for indicating a logic circuit verifying apparatus according to a ninth embodiment mode of the present invention.

FIG. 14 is a block diagram for indicating a logic circuit verifying apparatus according to a tenth embodiment mode of the present invention.

FIG. 15 is a block diagram for indicating a logic circuit verifying apparatus according to an eleventh embodiment mode of the present invention.

### DESCRIPTION OF THE PREFERRED EMBODIMENTS

Referring now to drawings, a description is made of various embodiment modes of the present invention.

### First Embodiment Mode

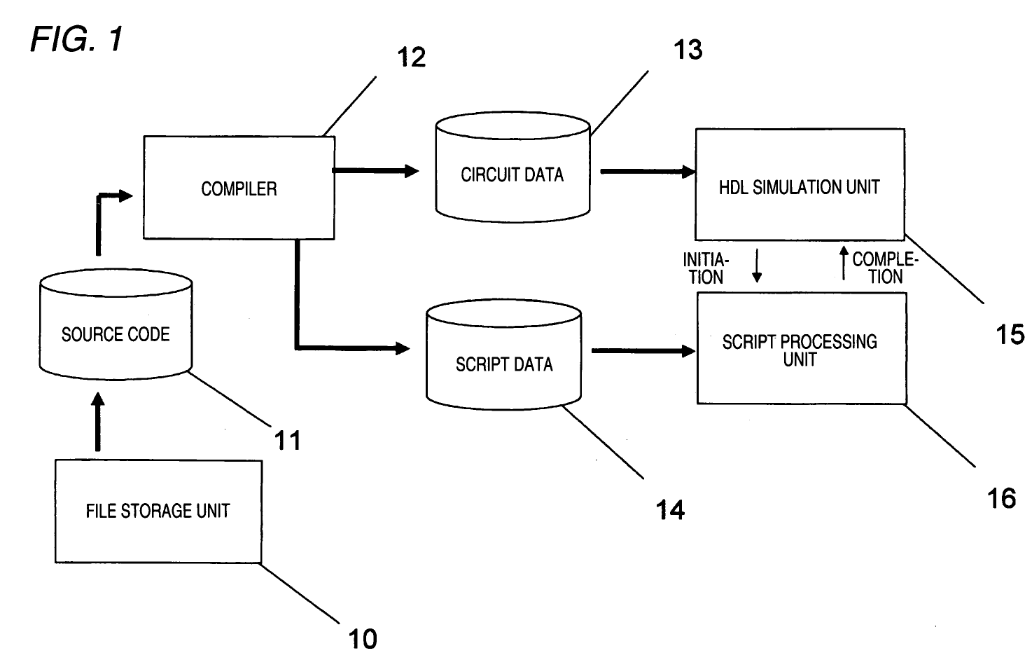

FIG. 1 is a block diagram for showing a logic circuit verifying apparatus according to a first embodiment mode of the present invention. As indicated in FIG. 1, the logic circuit verifying apparatus of the first embodiment mode is equipped with a file storage unit 10, a compiler 12, an HDL simulation unit 15, and a script processing unit 16.

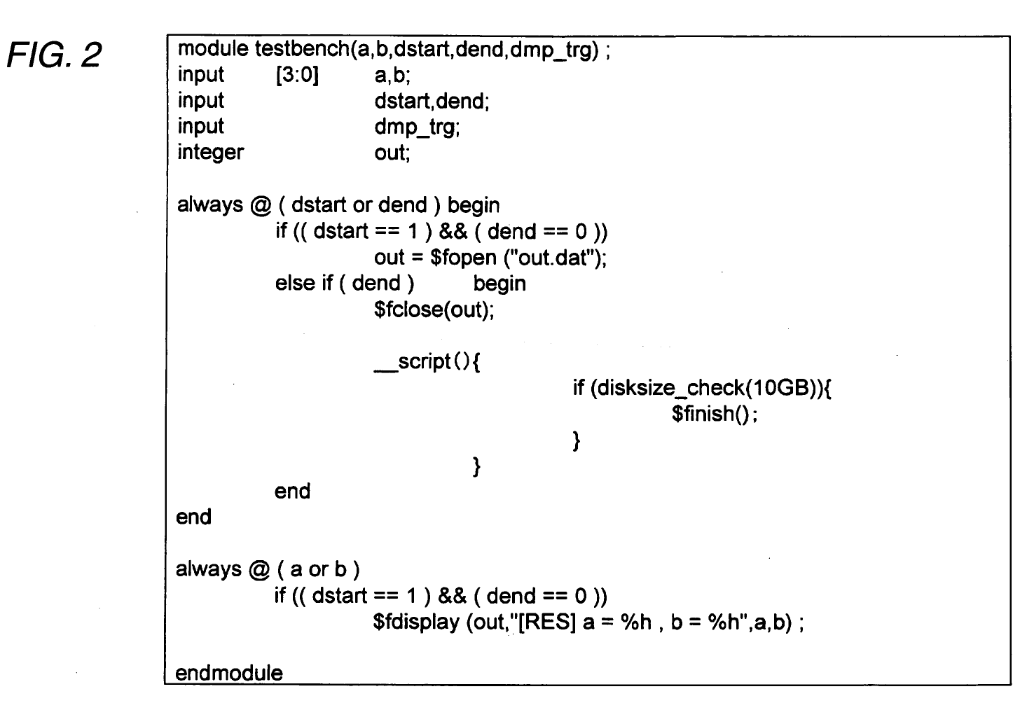

The file storage unit 10 stores a source code (refer to FIG. 2) where a script description has been embedded in an HDL description. Also, a file, a log file, and the like, which are produced in a simulation, are stored in the file storage unit 10.

The compiler 12 compiles an HDL description portion of the source code 11 read out from the file storage unit 10 to obtain such a format which can be produced by the HDL simulation unit 15, and also compiles a script description portion of the source code 1 to obtain a format which can be produced by the script processing unit 16. The data which is obtained by that the compiler 12 compiles the HDL description portion of the source code 11 is such a circuit data 13 indicated in FIG. 1. Also, the data which is obtained by that the compiler 12 compiles the script description portion of the source code 11 is such a script data 14 indicated in FIG. 1. After both the circuit data 13 and the script data 14 have been temporarily stored in a memory provided inside the compiler 12, the circuit data 13 is inputted to the HDL simulation unit 15, and the script data 14 is inputted in the script processing unit 16.

The HDL simulation unit 15 performs a simulation (function verification of logic circuit) by employing the circuit data 13. A script initiation-purpose trigger tag has been contained in the circuit data 13. When the HDL simulation unit 15 detects the script initiation-purpose trigger tag contained in the circuit data 13, the HDL simulation unit 15 initiates the script processing unit 16. The script processing unit 16 initiated by the HDL simulation unit 15 processes the script data 14. When the script processing unit 16 completes the process operation of the script data 14, the script processing unit 16 transmits a process completion notification to the HDL simulation unit 15.

While the script processing unit 16 processes the script data 14, the HDL simulation unit 15 is brought into an end notification waiting status as to the script processing operation by the script processing unit 16, so that the simulation is temporarily interrupted. When the HDL simulation unit 15 receives the process completion notification from the script processing unit 16, the HDL simulation unit 15 restarts the simulation of the circuit data 13.

The script description contained in the HDL description is, for example, a ┌_script ( )┘ function shown in FIG. 2. In this function, an empty storage capacity of the file storage unit 10 is confirmed by the script processing unit 16. It should also be noted that such a function name of ┌_script ( )┘ is one example, and therefore the present invention is not limited thereto.

As previously described, in accordance with the logic circuit verifying apparatus of the first embodiment mode, since the simulation is carried out while the empty storage capacity of the file storage unit 10 is confirmed, it is possible to avoid in advance that an error of this simulation occurs due to a shortage of an empty storage capacity of a recording medium. In the first embodiment mode, the circuit description has been made by employing the HDL (Hardware Description Language), and the means for simulating the circuit data has been realized as the HDL simulation unit. Alternatively, the circuit description may be made by employing a language having a higher abstract degree than that of the HDL, and the circuit data simulating means may be realized by such a simulator with a language having a hither abstract degree than that of this circuit data simulating means.

### Second Embodiment Mode

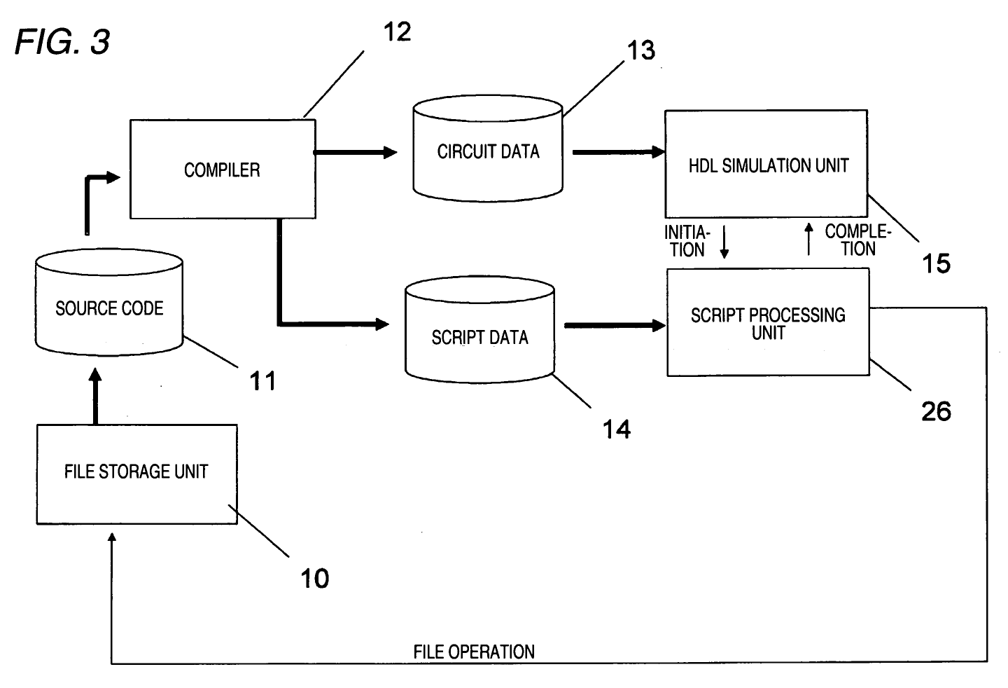

FIG. 3 is a block diagram for showing a logic circuit verifying apparatus according to a second embodiment mode of the present invention. As indicated in FIG. 3, the logic circuit verifying apparatus of the second embodiment mode is equipped with a script processing unit 26 instead of the script processing unit 16 which is provided in the logic circuit verifying apparatus of the first embodiment mode. The structural units of the second embodiment mode other than the above-described script processing unit 26 are similar to those of the first embodiment mode, and the same reference numerals shown in FIG. 3 have been applied to the structural elements which are commonly used in FIG. 1.

Based upon a script described in a source code 11, the script processing unit 26 of the second embodiment mode operates a file stored in the file storage unit 10 so as to delete a file which becomes unnecessary during simulation, and/or so as to compress a log file produced during simulation. As a consequence, in this second embodiment mode, a disk capacity used in the simulation can be reduced.

### Third Embodiment Mode

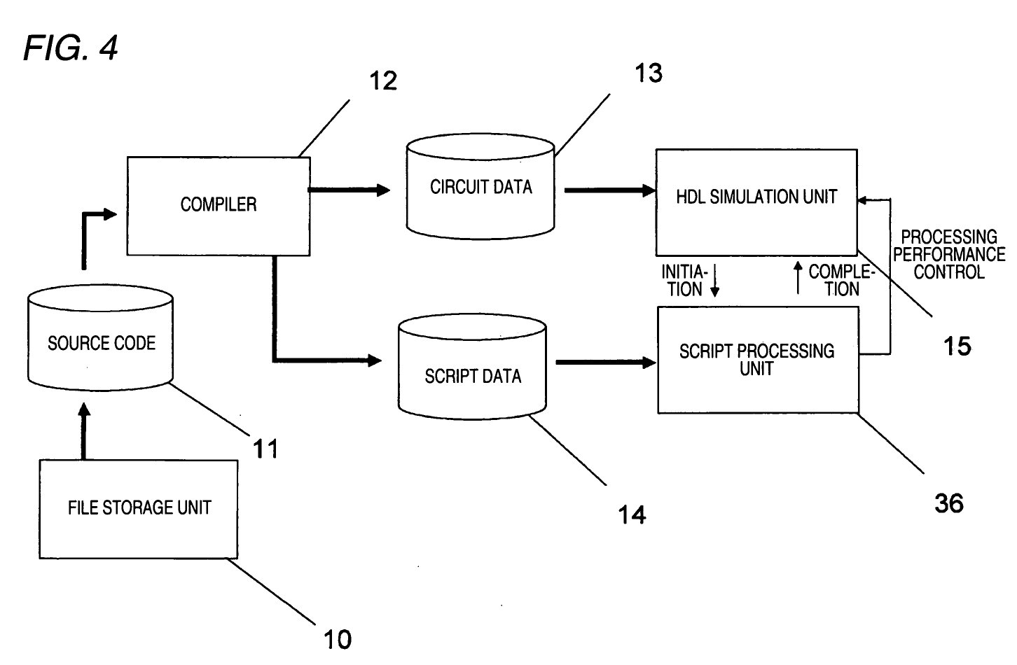

FIG. 4 is a block diagram for showing a logic circuit verifying apparatus according to a third embodiment mode of the present invention. As indicated in FIG. 4, the logic circuit verifying apparatus of the third embodiment mode is equipped with a script processing unit 36 instead of the script processing unit 16 which is provided in the logic circuit verifying apparatus of the first embodiment mode. The structural units of the third embodiment mode other than the above-described, script processing unit 36 are similar to those of the first embodiment mode, and the same reference numerals shown in FIG. 4 have been applied to the structural elements which are commonly used in FIG. 1.

Based upon a script described in a source code 11, the script processing unit 36 of the third embodiment mode controls processing performance of the HDL simulation unit 15. In accordance with this third embodiment mode, when there is no urgent request to confirm a processed result of the HDL simulation unit 15, the power consumption of the HDL simulation unit 15 can be suppressed by lowering the operating voltage of the HDL simulation unit 15, or lowering the operating frequency of the HDL simulation unit 15.

### Fourth Embodiment Mode

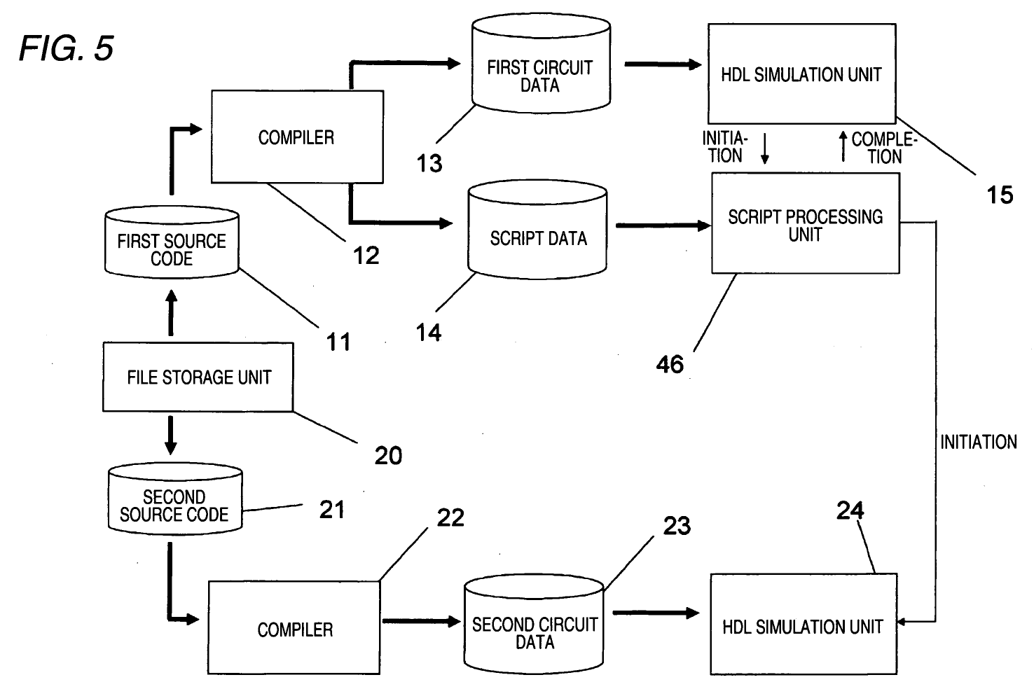

FIG. 5 is a block diagram for showing a logic circuit verifying apparatus according to a fourth embodiment mode of the present invention. As indicated in FIG. 5, the logic circuit verifying apparatus of the fourth embodiment mode is equipped with a script processing unit 46 instead of the script processing unit 16 which is provided in the logic circuit verifying apparatus of the first embodiment mode. The logic circuit verifying apparatus of the fourth embodiment mode is further equipped with a compiler 22 and an HDL simulation unit 24. The structural units of the fourth embodiment mode other than these structural units 46, 22, and 24 are similar to those of the first embodiment mode, and the same reference numerals shown in FIG. 5 have been applied to the structural elements which are commonly used in FIG. 1. It should be noted that the file storage unit 20 of this fourth embodiment mode stores thereinto a first source code 11 and a second source code 20.

The compiler 12 reads out the first source code 11 from a file storage unit 20 in a substantially similar manner to that of the first embodiment mode. Since the compiler 12 compiles the read first source code 11, both first circuit data 13 and script data 14 are obtained, so that the first circuit data 13 is inputted to the HDL simulation unit 15, and the script data 14 is inputted to the script processing unit 46. The script processing unit 46 of the fourth embodiment mode initiates the HDL simulation unit 24 based upon a script described in the first source code 11.

On the other hand, the compiler 22 reads out the second source code 21 from the file storage unit 20. Since the compiler 22 compiles the read second source code 21, second circuit data 23 is obtained, so that the second circuit data 23 is inputted to the HDL simulation unit 24. The HDL simulation unit 24 initiated by the script processing unit 46 simulates the second circuit data 23.

As previously described, in accordance with the logic circuit verifying apparatus of the fourth embodiment mode, in the case that two sets of the test patterns are simulated, the simulation of the resembled test pattern can be carried out by the HDL simulation unit 24 as soon as the HDL simulation unit 15 can confirm the basic portion of the typical test pattern while the completion of the HDL simulation unit 15 is not waited.

It should be noted that although the fourth embodiment mode has explained such an example as to two sets of the source codes, the source codes are not limited only to two source codes, but may be selected to be 3, or more sets of source codes. Also, as to the second source code 21, the script data is not produced, but also the script process operation is not carried out. Alternatively, while another script processing unit is made of the same structure as that of the script processing unit 46, this script processing unit may be connected to the compiler 22 and the HDL simulation unit 24, so that the second source code 21 may be script-processed.

### Fifth Embodiment Mode

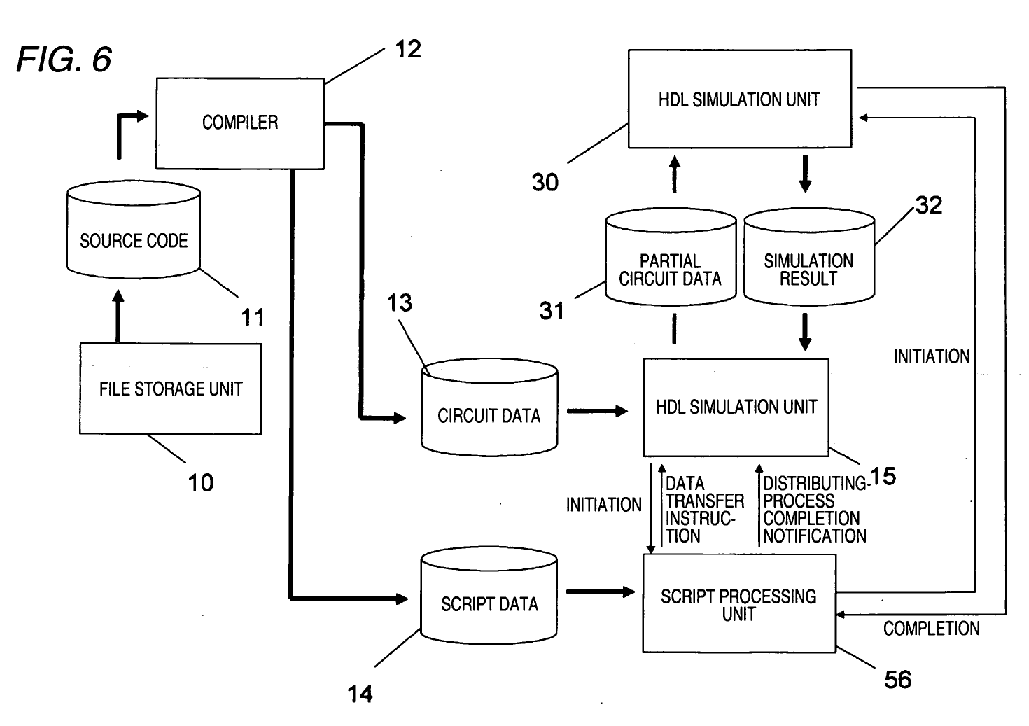

FIG. 6 is a block diagram for showing a logic circuit verifying apparatus according to a fifth embodiment mode of the present invention. As indicated in FIG. 6, the logic circuit verifying apparatus of the fifth embodiment mode is equipped with a script processing unit 56 instead of the script processing unit 16 provided in the logic circuit verifying apparatus of the first embodiment mode. The logic circuit verifying apparatus of the fifth embodiment mode is further equipped with an HDL simulation unit 30. The structural units of the fifth embodiment mode other than the above-described structural units are similar to those of the first embodiment mode, and the same reference numerals indicated in FIG. 6 have been applied to the structural elements which are commonly used in FIG. 1.

In this fifth embodiment mode, a script for executing a parallel process operation with the HDL simulation-unit 15 with employment of the HDL simulation unit 30 has been described in the source code 11. When this script for executing the parallel process operation is processed by the script processing unit 56, the script processing unit 56 instructs the HDL simulation unit 15 in such a manner that partial circuit data 31 is transferred to the HDL simulation unit 30 so as to be simulation-processed in a distribution manner. It should be understood that the partial circuit data 31 corresponds to such a partial data of the circuit data 13. Also, the script processing unit 56 instructs the HDL simulation unit 30 to commence a simulation as soon as the HDL simulation unit 30 receives the partial circuit data 31 from the HDL simulation unit 15.

When the HDL simulation unit 30 accomplishes the simulation, the HDL simulation unit 30 sends a completion notification to the script processing unit 56, and transmits a simulation result 32 to the HDL simulation unit 15. The script processing unit 56 which has received the completion notification from the HDL simulation unit 30 transmits a distribution process completion notification to the HDL simulation unit 15. The HDL simulation unit 15 which has received the distribution process completion notification receives the simulation result 32 sent from the HDL simulation unit 30.

As previously described, in accordance with the logic circuit verifying apparatus of this fifth embodiment mode, in such a case that the load given to the HDL simulation unit 15 becomes heavy, the partial circuit data can be processed in the distribution process manner by the HDL simulation unit 30, so that the load given to the HDL simulation unit 15 can be reduced. As a consequence, the logic circuit verifying apparatus can accomplish the simulation earlier than that of such a case that the distribution process operation is not carried out.

Although the fifth embodiment mode has described such a case that the HDL simulation unit 30 for performing the parallel process operation is only one unit, 2, or more sets of such HDL simulation units 30 may be alternatively employed.

### Sixth Embodiment Mode

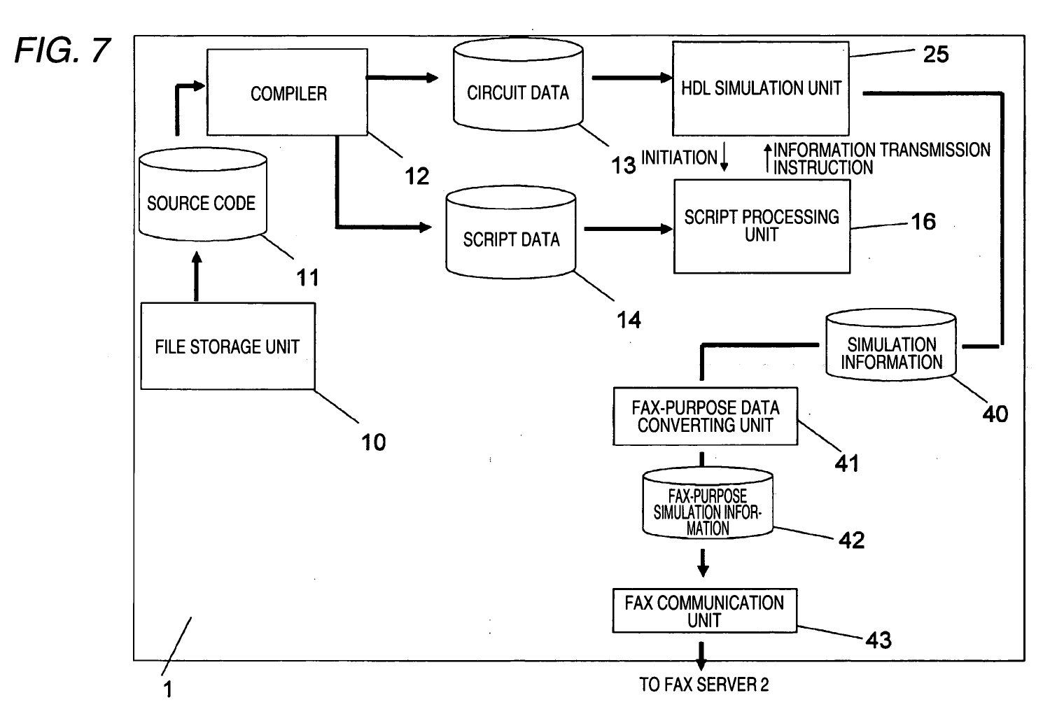

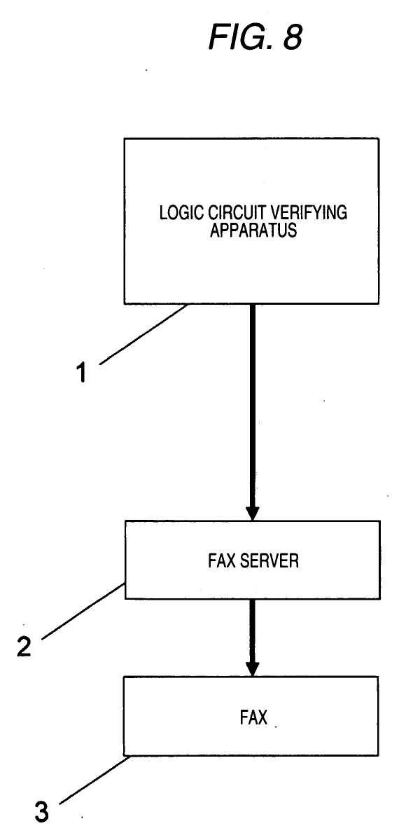

FIG. 7 is a block diagram for showing a logic circuit verifying apparatus according to a sixth embodiment mode of the present invention. As indicated in FIG. 7, the logic circuit verifying apparatus of the sixth embodiment mode is equipped with an HDL simulation unit 25 instead of the HDL simulation unit 15 provided in the logic circuit verifying apparatus of the first embodiment mode. The logic circuit verifying apparatus of this sixth embodiment mode is further equipped with a FAX-purpose data converting unit 41 and a FAX communication unit 43. The structural units of the sixth embodiment mode other than the above-described structural units are similar to those of the first embodiment mode, and the same reference numerals indicated in FIG. 7 have been applied to the structural elements which are commonly used in FIG. 1. FIG. 8 is a block diagram for showing a system which contains the logic circuit verifying apparatus 1 of the sixth embodiment mode, a FAX server 2, and a FAX 3. The FAX server 2 has been connected to the logic circuit verifying apparatus 1, and the FAX 3 has been connected to the FAX server 2.

In this sixth embodiment mode, such a script has been described in the source code 11, while this script instructs that the HDL simulation unit 25 temporarily interrupts a simulation, and simulation information 40 is transmitted from the HDL simulation unit 25 to the FAX-purpose data converting unit 41. When this script is processed by the script processing unit 16, the script processing unit 16 instructs the HDL simulation unit 25 in such a manner that the simulation is interrupted and the simulation information 40 is transmitted to the FAX-purpose data converting unit 41. The HDL simulation unit 25 of the sixth embodiment mode transmits the simulation information 40 obtained from the simulation result to the FAX-purpose data converting unit 41. The FAX-purpose data converting unit 41 converts the simulation information 40 into FAX-purpose simulation information 42 which corresponds to FAX transmission-purpose data. The FAX communication unit 43 transmits the FAX-purpose simulation information to the FAX server 2.

As previously described, in accordance with the logic circuit verifying apparatus of this sixth embodiment mode, an operator located at a remote place can receive such information related to simulation results in progress via a FAX, for instance, a value of a register, a value of a memory, and a status of a circuit.

### Seventh Embodiment Mode

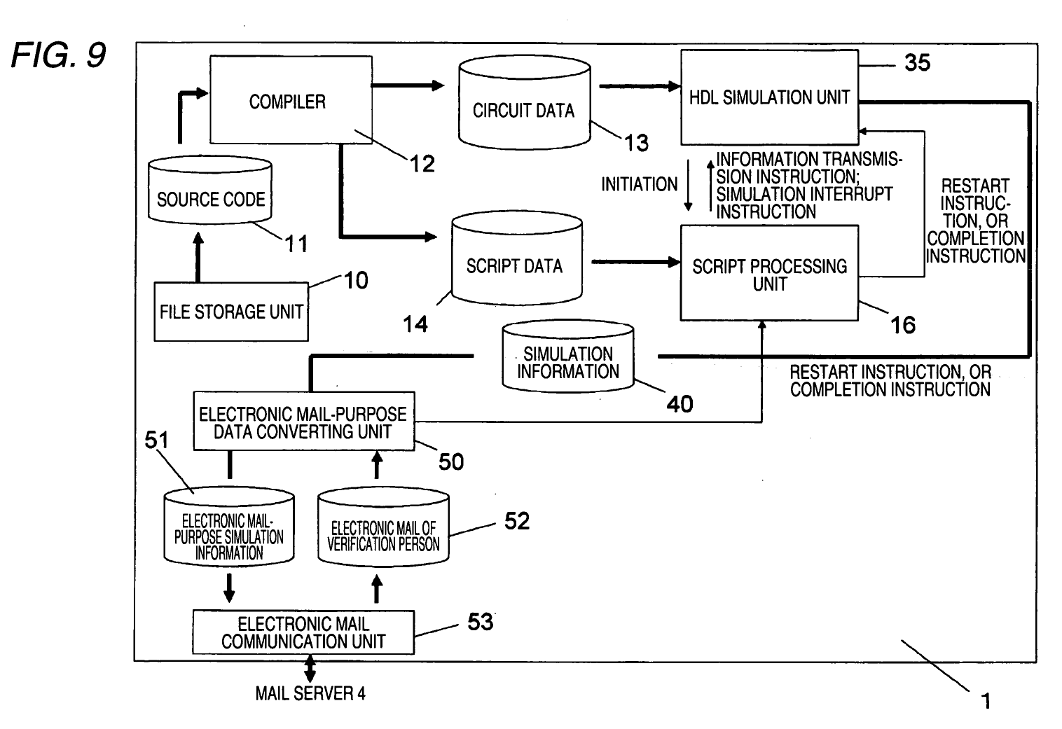

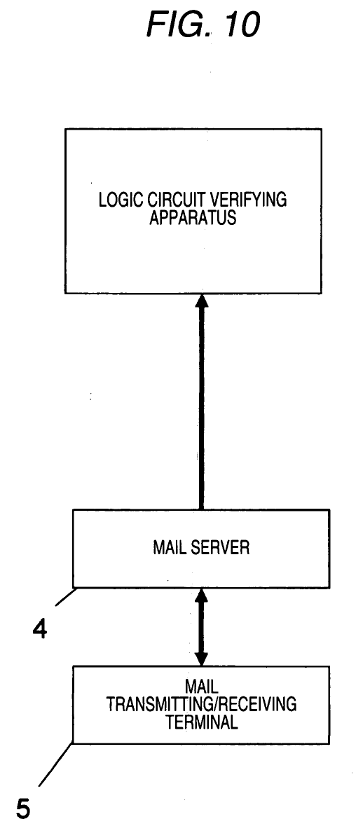

FIG. 9 is a block diagram for showing a logic circuit verifying apparatus according to a seventh embodiment mode of the present invention. As indicated in FIG. 9, the logic circuit verifying apparatus of the seventh embodiment mode is equipped with an HDL simulation unit 35 instead of the HDL simulation unit 15 provided in the logic circuit verifying apparatus of the first embodiment mode. The logic circuit verifying apparatus of this seventh embodiment mode is further equipped with an electronic mail-purpose converting unit 50 and an electronic mail communication unit 53. The structural units of the seventh embodiment mode other than the above-described structural units are similar to those of the first embodiment mode, and the same reference numerals indicated in FIG. 9 have been applied to the structural elements which are commonly used in FIG. 1. FIG. 10 is a block diagram for showing a system which contains the logic circuit verifying apparatus 1 of the seventh embodiment mode, a mail server 4, and a mail transmitting/receiving terminal 5. The mail server 4 has been connected to the logic circuit verifying apparatus 2, and the mail transmitting/receiving terminal 5 has been connected to the mail server 4.

In this seventh embodiment mode, such a script has been described in the source code 11, while this script instructs that the HDL simulation unit 35 temporarily interrupts a simulation, and simulation information 40 is transmitted from the HDL simulation unit 25 to an operator via an electronic mail; and the HDL simulation unit 35 receives an electronic mail from the operator so as to restart, or accomplish the simulation. When this script is processed by the script processing unit 16, the script processing unit 16 instructs the HDL simulation unit 35 in such a manner that the simulation is interrupted and the simulation information 40 is transmitted to the electronic mail-purpose data converting unit 50. The HDL simulation unit 35 of the seventh embodiment mode transmits the simulation information 40 such as a value of a register, a value of a memory, and a status of a circuit to the electronic mail-purpose data converting unit 50. The electronic mail-purpose data converting unit 50 converts the simulation information 40 into electronic mail-purpose simulation information 51 having a format which can be transmitted via an electronic mail. The electronic mail communication unit 53 transmits the electronic mail-purpose simulation information 51 to the mail server 4.

The mail transmitting/receiving terminal 5 receives an electronic mail from the mail server 4. A operator who operates the mail transmitting/receiving terminal 5 judges whether the simulation is restarted, or ended based upon the simulation information received by the electronic mail. The mail transmitting/receiving terminal 5 transmits an electronic mail containing this judgement result via the mail server 4 to the logic circuit verifying apparatus 1. The electronic mail communication unit 53 receives an electronic mail 52, and inputs this received electronic mail 52 to the electronic mail-purpose data converting unit 50. The electronic mail-purpose data converting unit 50 interprets the content of the electronic mail 52, and converts this electronic mail 52 into either an instruction for restarting the simulation or an instruction for ending the simulation, and then inputs the converted instruction to the script processing unit 16. The script processing unit 16 inputs either the simulation restarting instruction or the simulation ending instruction to the HDL simulation unit 35.

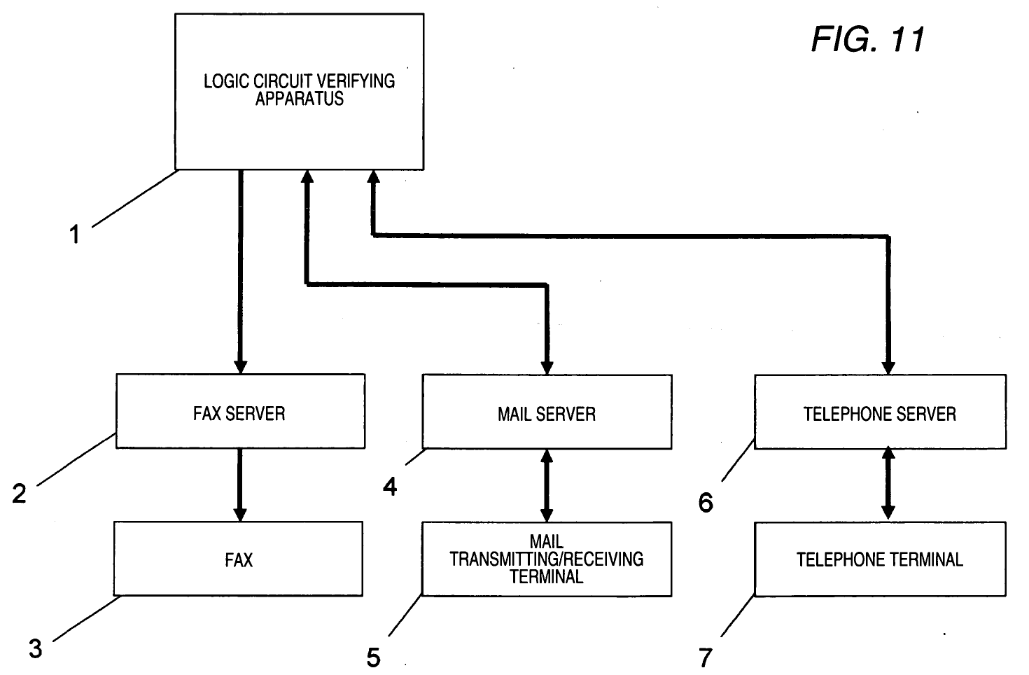

As previously described, in accordance with the logic circuit verifying apparatus of this seventh embodiment mode, the operator located at the remote place can perform the simulation by employing the electronic mail. It should also be noted that the communication system to be utilized is not limited only to an electronic mail. For instance, while the electronic mail-purpose data converting unit 50 is defined as a telephone-purpose data converting unit and the electronic mail communication unit 53 is defined as a telephone-purpose communication unit, as represented in FIG. 11, the logic circuit verifying apparatus 1, the telephone server 6, and the telephone terminal 7 may be arranged as a system. In this alternative case, the telephone-purpose data converting unit converts simulation information corresponding to character data into voice, and also, converts voice acquired from an external source (not shown) into character data. Also, as shown in FIG. 11, any one of the FAX server 2, the mail server 4, and the telephone server 6 is not connected to the logic circuit verifying apparatus 1, but all of these three units, or any two of these units may be alternatively connected to the logic circuit verifying apparatus 1.

### Eight Embodiment Mode

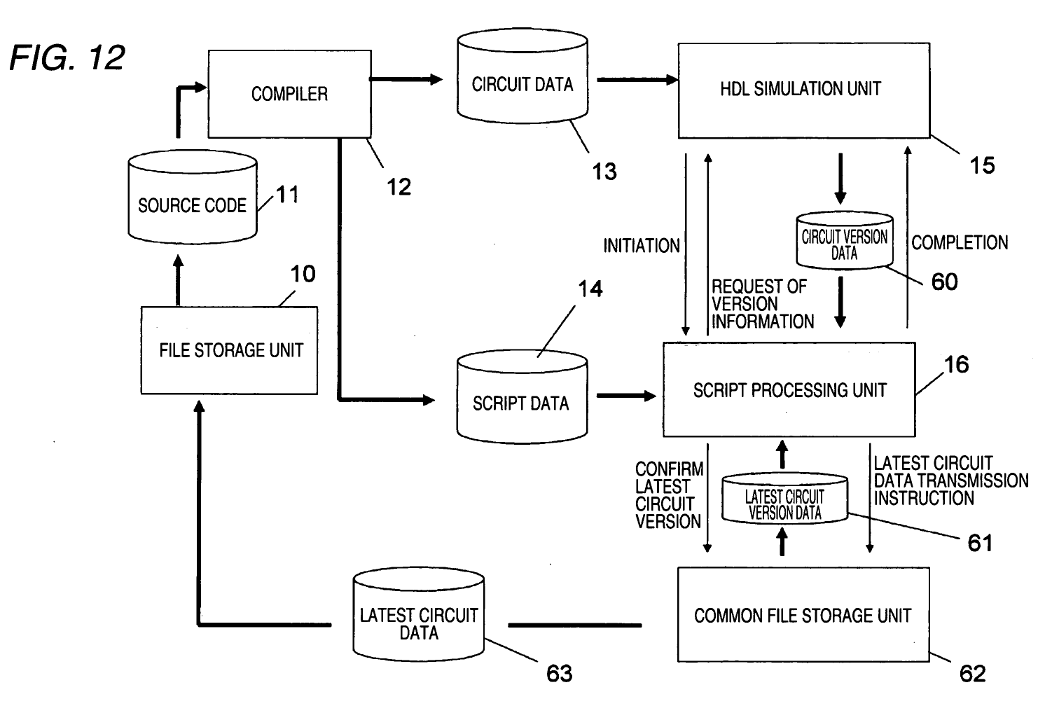

FIG. 12 is a block diagram for showing a logic circuit verifying apparatus according to an eighth embodiment mode of the present invention. As indicated in FIG. 12, the logic circuit verifying apparatus of the fifth embodiment mode is furthermore equipped with a common file storage unit 62 in addition to the structural elements provided in the logic circuit verifying apparatus of the first embodiment mode. The structural units of the eighth embodiment mode other than the above-described structural units are similar to those of the first embodiment mode, and the same reference numerals indicated in FIG. 12 have been applied to the structural elements which are commonly used in FIG. 1.

In this eighth embodiment mode, such a script has been described in the source code 11, while this script describes that the latest version information of the circuit is inquired to the common file storage unit 62; the HDL simulation unit 15 compares version information of a circuit to be simulated with the latest version information of the circuit; when the version information of the circuit which is tried to be simulated by the HDL simulation unit 15 is older than the above-described latest circuit version information, the latest circuit data 63 is received from the common file storage unit 62, and the simulation of the HDL simulation unit 15 is accomplished.

When this script is processed by the script processing unit 16, the script processing unit 16 issues a request of version information of a simulation circuit with respect to the HDL simulation unit 15. The HDL simulation circuit 15 which has received the request of the version information inputs circuit version data 60 in the script processing unit 16. Also, the script processing unit 16 requests the latest circuit version data 61 with respect to the common file storage unit 62, and also, compares the circuit version data 60 entered from the HDL simulation unit 15 with the latest circuit version data 61. When the circuit version data 60 is older than the latest circuit version data 61, the script processing unit 16 instructs the common file storage unit 62 in such a manner that the latest circuit data 63 is transmitted to the file storage unit 10. The common file storage unit 62 which has received this instruction inputs the latest circuit data 63 to the file storage unit 10.

As previously described, in accordance with the logic circuit verifying apparatus of the eighth embodiment mode, the script for confirming the version information of the circuit and for updating the file has been embedded in the circuit data. As a result, such an error can be prevented in advance. That is, in this error, the latest circuit data 63 is mistakenly downloaded from the file storage unit 10, and thus, the HDL simulation unit 15 mistakenly performs the simulation based upon the old circuit version information.

### Ninth Embodiment Mode

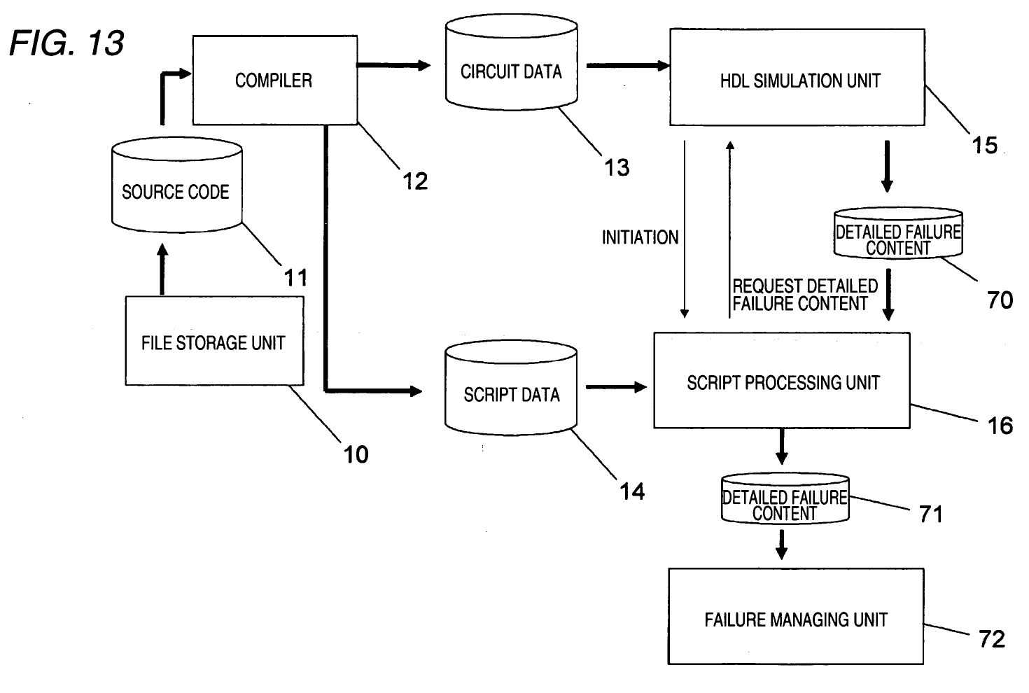

FIG. 13 is a block diagram for showing a logic circuit verifying apparatus according to a ninth embodiment mode of the present invention. As indicated in FIG. 13, the logic circuit verifying apparatus of the ninth embodiment mode is furthermore equipped with a failure managing unit 72 in addition to the structural elements provided in the logic circuit verifying apparatus of the first embodiment mode. The structural units of the ninth embodiment mode other than the above-described structural units are similar to those of the first embodiment mode, and the same reference numerals indicated in FIG. 13 have been applied to the structural elements which are commonly used in FIG. 1.

In this ninth embodiment mode, such a script has been described in an HDL description portion of the source code 11, while the script instructs that a combination of signal statuses which can hardly occur during normal operation is defined as a failure; in such a case that this defined failure happens to occur, the HDL simulation unit 15 inputs a detailed content 70 of the failure to the script processing unit 16; and the script processing unit 16 inputs a detailed content 71 of the failure to the failure managing unit 72.

When a failure happens to occur during a simulation executed by the HDL simulation unit 15, the above-described script is processed by the script processing unit 16. At this time, the script processing unit 16 requests the HDL simulation unit 15 to inform a detailed content of this failure. The HDL simulation unit 15 which has received the request of the detailed failure content sends a detailed failure content 70 to the script processing unit 16, while the detailed failure content 70 indicates a status of a circuit around a failure occurring portion when the failure occurs. The script processing unit 16 stores the detailed failure content 71 in the failure managing unit 72. The failure managing unit 72 stores thereinto the sent detailed failure content 71.

As previously described, in accordance with the logic circuit verifying apparatus of this ninth embodiment mode, such a circuit which has been registered as the failure based upon the status of the circuit by the operator is simulated by the logic circuit verifying apparatus. As a result, it is possible to avoid that registering of the failures is forgotten, and also, possible to reduce a total step number of the registration of the failures.

### Tenth Embodiment Mode

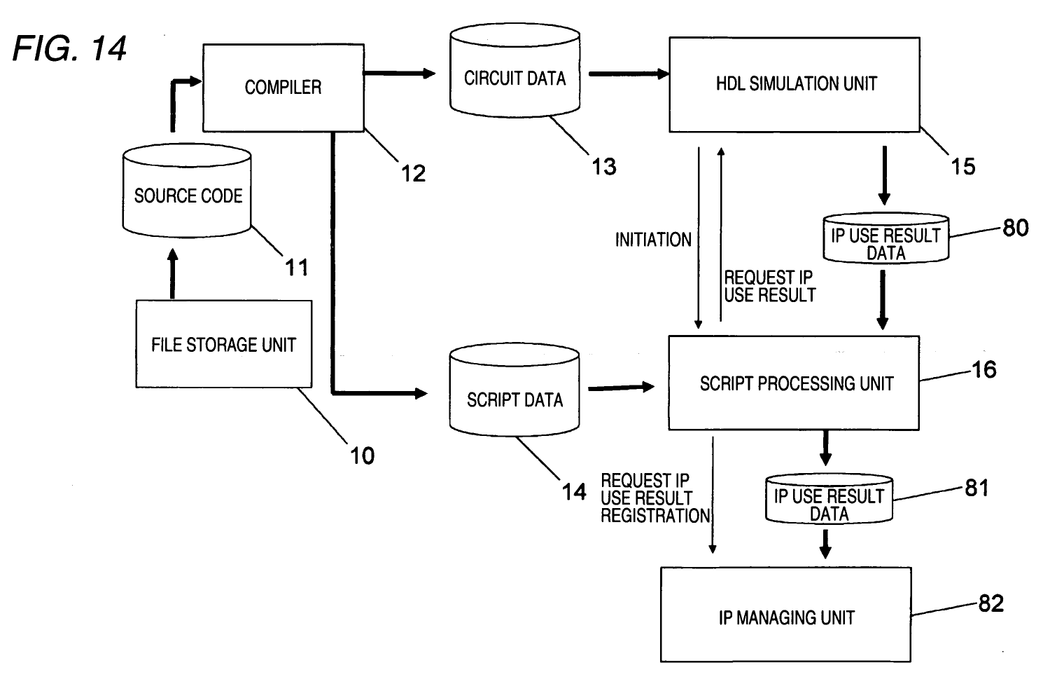

FIG. 14 is a block diagram for showing a logic circuit verifying apparatus according to a tenth embodiment mode of the present invention. As indicated in FIG. 14, the logic circuit verifying apparatus of the tenth embodiment mode is furthermore equipped with an IP (Internet Protocol) managing unit 82 in addition to the structural elements provided in the logic circuit verifying apparatus of the first embodiment mode. The structural units of the tenth embodiment mode other than the above-described structural units are similar to those of the first embodiment mode, and the same reference numerals indicated in FIG. 14 have been applied to the structural elements which are commonly used in FIG. 1.

In this tenth embodiment mode, such a script description has been embedded in the source code 11, while this script notifies use results of an IP to the IP managing unit 82. When the HDL simulation unit 15 simulates an IP, the script processing unit 16 processes this script. At this time, the script processing unit 16 issues a request of IP use results with respect to the HDL simulation unit 15. The HDL simulation unit 15 which has received the IP use results request transmits IP use results data 80 to the script processing unit 16. The script processing unit 16 transmits IP use results data 81 to the IP managing unit 82. The IP managing unit 82 registers the sent IP use results data 81.

As previously explained, in accordance with the logic circuit verifying apparatus of the tenth embodiment mode, the IP supply source can acquire the use results data 81 of the IP. It should also be noted that the IP use results data 81 corresponds to such information as to a function where IP is used in a simulation, a parameter set when a simulation is carried out, and a simulation frequency.

### Eleventh Embodiment Mode

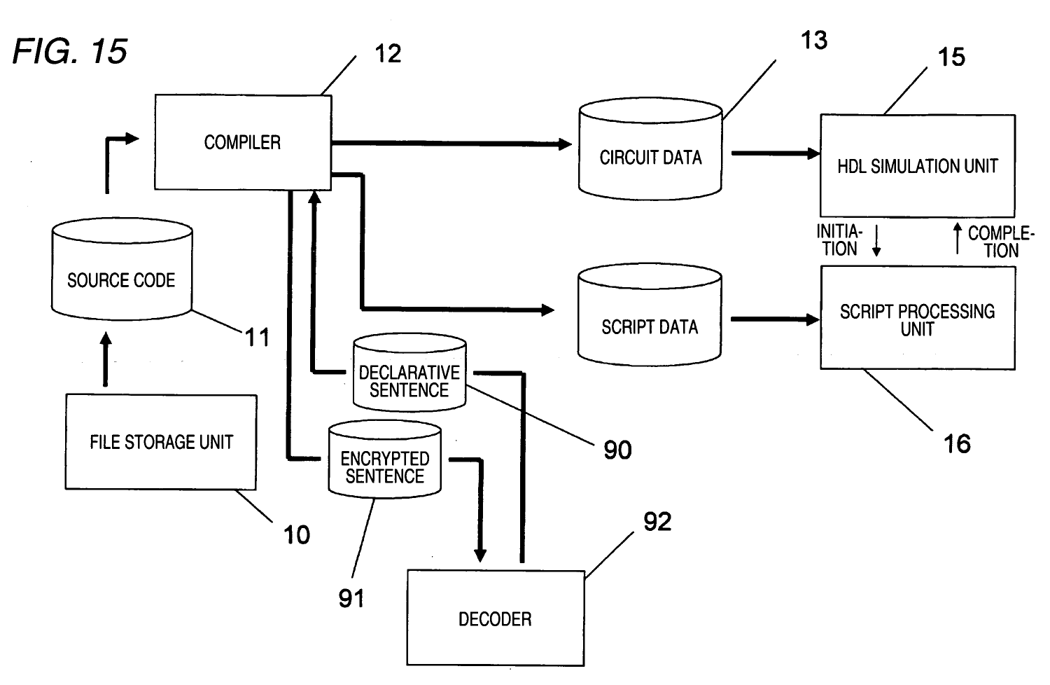

FIG. 15 is a block diagram for showing a logic circuit verifying apparatus according to an eleventh embodiment mode of the present invention. As indicated in FIG. 15, the logic circuit verifying apparatus of the eleventh embodiment mode is furthermore equipped with a decoder 92 in addition to the structural elements provided in the logic circuit verifying apparatus of the first embodiment mode. The structural units of the eleventh embodiment mode other than the above-described structural units are similar to those of the first embodiment mode, and the same reference numerals indicated in FIG. 15 have been applied to the structural elements which are commonly used in FIG. 1.

In this eleventh embodiment mode, when the compiler 12 detects an encrypted sentence 91 during compiling operation, the compiler 12 inputs the detected encrypted sentence 91 to the decoder 92. The decoder 92 decodes the encrypted sentence 91 so as to enter a declarative sentence 90 to the compiler 12. The compiler 12 compiles the declarative sentence 90.

As previously described, in accordance with the logic circuit verifying apparatus of this eleventh embodiment mode, the script description can be encrypted. As a result, the release source of the source code 11 can embed such a script whose content is not wanted to be grasped by a person who executes a simulation.

The logic circuit verifying apparatus according to the present invention is useful as an apparatus for verifying a logic circuit (namely, HDL simulator), which can automatically control an execution of another simulation and also can automatically perform a file operation in response to simulation reports in progress.

What is claimed is:

1. A logic circuit verifying apparatus comprising:
a first storage unit for storing thereinto circuit design information described in a hardware description language, in which a script description has been embedded in a description described in said hardware description language;
a data converting unit for converting the hardware description portion of said circuit design information into first circuit data by compiling said circuit design information read from said first storage unit, and for converting the script description portion of said circuit design information into script data;
a first simulation unit for performing a simulation by employing said first circuit data inputted from said data converting unit; and
a script processing unit into which said script data is inputted from said data converting unit, and which processes said script data in response to an instruction issued from said first simulation unit.

2. A logic circuit verifying apparatus comprising:
a first storage unit for storing thereinto first circuit design information described in a hardware description language, in which a script description has been embedded in a description described in said hardware description language, and for storing thereinto second circuit design information described in said hardware description language;
a first data converting unit for converting the hardware description portion of said first circuit design information into first circuit data by compiling said first circuit design information read from said first storage unit, and for converting the script description portion of said first circuit design information into script data;
a second data converting unit for converting the hardware description portion of said second circuit design information into second circuit data by compiling said second circuit design information read from said first storage unit;
a first simulation unit for performing a simulation by employing said first circuit data inputted from said first data converting unit;
a script processing unit into which said script data is inputted from said first data converting unit, and which processes said script data in response to an instruction issued from said first simulation unit; and
a second simulation unit for performing a simulation by employing said second circuit data inputted from said second data converting unit in response to an instruction issued from said script processing unit.

3. A logic circuit verifying apparatus as claimed in claim 1 wherein:
said first simulation unit temporarily interrupts said simulation while said script processing operation is carried out by said script processing unit, and restarts said simulation when said first simulation unit receives a script processing operation completion notification from said script processing unit.

4. The logic circuit verifying apparatus as claimed in claim 1 wherein:
either a file or a log file, which are produced while the simulation is performed by said first simulation unit, is stored in said first storage unit; and
said script processing unit deletes, or compresses the file stored in said first storage unit by processing said script data.

5. The logic circuit verifying apparatus as claimed in claim 1 wherein:
said script processing unit processes said script data so as to control either an operating voltage or an operating frequency of said first simulation unit.

6. The logic circuit verifying apparatus as claimed in claim 1 wherein:
said logic circuit verifying apparatus is further comprised of:
a second simulation unit for performing a simulation by employing a portion of said first circuit data transferred from said first simulation unit;
said script processing unit processes said script data so as to instruct said first simulation unit in such a manner that said portion of the first circuit data is transferred to said second simulation unit in order to process said transferred data portion of the first circuit data in a distribution process manner; and
said script processing unit processes said script data so as to instruct said second simulation unit to start a simulation by employing the data portion of said first circuit data as soon as the data portion of said first circuit data is transferred.

7. The logic circuit verifying apparatus as claimed in claim 6 wherein:
when the second simulation unit accomplishes the simulation by employing the data portion of said first circuit data, said second simulation unit sends a completion notification to said script processing unit, and also, sends a simulation result to said first simulation unit; and
when said script processing unit receives said completion notification, said script processing unit sends a distribution process operation completion notification to said first simulation unit.

8. The logic circuit verifying apparatus as claimed in claim 1 wherein:
said first simulation unit outputs simulation information indicative of reports in progress of said simulation which has been temporarily interrupted by that said script processing unit processes said script data; and wherein:
said logic circuit verifying apparatus is further comprised of:
a data format converting unit for converting said simulation information outputted from said first simulation unit into a data format for externally outputting said simulation information; and
a data communication unit for outputting said externally-outputting simulation information converted by said data format converting unit to an external unit of said logic circuit verifying apparatus.

9. The logic circuit verifying apparatus as claimed in claim 8 wherein:
said data format converting unit converts said simulation information into a FAX output-purpose data format; and
said data communication unit outputs said externally-outputting simulation information via a FAX (facsimile).

10. The logic circuit verifying apparatus as claimed in claim 8 wherein:
said data format converting unit converts said simulation information into an electronic mail output-purpose data format; and
said data communication unit outputs said externally-outputting simulation information via an electronic mail.

11. The logic circuit verifying apparatus as claimed in claim 10 wherein:
said data communication unit receives an instruction for restarting, or stopping said simulation via an electronic mail.; and
said script processing unit instructs said first simulation unit to stop, or restart said simulation based upon said instruction.

12. The logic circuit verifying apparatus as claimed in claim 8 wherein:
said data format converting unit converts said simulation information into a voice output-purpose data format; and
said data communication unit outputs said externally-outputting simulation information via voice.

13. A logic circuit verifying apparatus as claimed in claim 12 wherein:
said data communication unit receives said instruction for restarting, or stopping said simulation via voice; and
said script processing unit instructs said first simulation unit to stop, or restart said simulation based upon said instruction.

14. The logic circuit verifying apparatus as claimed in claim 1 wherein:
said logic circuit verifying apparatus is further comprised of:
a second recording unit for storing thereinto second circuit data and attribute information of said second circuit data; and
a comparing unit for comparing the attribute information of said first circuit data with the attribute information of said second circuit data by processing said script data by said script processing unit.

15. The logic circuit verifying apparatus as claimed in claim 1 wherein:
said logic circuit verifying apparatus is further comprised of:
a failure managing unit for storing thereinto information related to a failure which occurs in a simulation performed by said first simulation unit; and wherein:
said script processing unit processes said script data so as to store the information related to the failure acquired from said first simulation unit in said failure managing unit.

16. A logic circuit verifying apparatus as claimed in claim 1 wherein:
said logic circuit verifying apparatus is further comprised of:
an IP managing unit for storing thereinto information related to use results of an IP (Internet Protocol) which has been used in a simulation by said first simulation unit; and wherein:
said script processing unit processes said script data so as to store the information related to the use results of the IP acquired from said first simulation unit in said IP managing unit.

17. The logic circuit verifying apparatus as claimed in claim 1 wherein:
said logic circuit verifying apparatus is further comprised of:
an encrypted sentence decoding unit for decoding an encrypted sentence contained in said circuit design information.
